(19) United States
(12) Patent Application Publication
(10) Pub. No.: US 2026/0237317 A1
(43) Pub. Date: Aug. 13, 2026

(54) System and method for two-way interactions with the speaker in a pre-recorded video

(71) Applicant: Indraneel Das, Tampa, FL (US)

(72) Inventor: Indraneel Das, Tampa, FL (US)

(21) Appl. No.: 19/051,258

(22) Filed: Feb. 12, 2025

(51) Int. Cl. G09B 5/06; G06F 16/3329; G09B 7/00

(52) U.S. Cl. CPC G09B 5/06; G06F 16/33295; G09B 7/00

(57) ABSTRACT

Systems and methods are provided for two-way interactions with an instructor in a video where one or more students can have separate, concurrent conversations with the instructor, possibly in a different language, via the instructor's AI avatar that resembles the instructor in appearance, voice, tone, and/or other nuances, thereby providing solutions for significant drawbacks of distance learning via pre-recorded video because it does not permit a student to interact with the instructor in a video during the lecture.

### CROSS-REFERENCE TO RELATED APPLICATIONS

This application claims the benefit of U.S. Patent Application Ser. No. 63/637,698, filed on Apr. 23, 2024, which is hereby incorporated by reference herein in its entirety.

### FIELD OF THE INVENTION

The invention relates to systems and methods for two-way interactions with a speaker using pre-recorded media (e.g., video, audio, images) that can have various uses, including but limited to as a teaching aid.

### BACKGROUND OF THE INVENTION

Pre-recorded media has various uses such as where a speaker attempts to communicate with listeners (“listeners” are also referred to herein as “users”). This can include videos where a speaker communicates with listeners who are watching and listening on tablets, hand-held devices, and computer screens.

One example of such use is in education where there are a number of problems in reaching students. In this regard, there are 250 million school age children worldwide that do not attend school (UNESCO report, 2024). Even in a developed countryies such as the U.S. where more than $14,000 are spent annually per K-12 student, the reading and math proficiency scores have continue to declined at alarming rates in recent years. Part of the problem is that the teachers are relatively underpaid given their education level, there is a high burnout rate of teachers, and there are glaring gaps in staffing of teachers in schools. Recent events (e.g., the Covid-19 pandemic, civil unrest, war) have added to these problems. Higher education (e.g., college) is also suffering, with less total undergraduates enrolling in degree-granting postsecondary institutions. Indicators reveal there are systemic barriers to college access and success for low-income and non-traditional students. In the United States, the cost of attending college, in many cases, has ceased to be consistent with a decent return on investment based on job opportunities after graduation college

Attempted solutions such as videos from MIT, YouTube, Coursera, Udemy, and other sources have been put out there but they are not solving the problems. We think issues such as language barriers and the inability to interact with an instructor in a video are two main barriers, which, if removed, will unlock the next leg of progress in education. Of relevance is the “two sigma problem” identified by psychologist Benjamin Bloom in 1984, where students do better with one-to-one tutoring, but attaining that has not been possible due to cost and scalability issues. Our system can effectively provide one-on-one tutoring with interactivity at scale using our technology effectively

Yet education has been proposed as the key to reducing poverty and therefore, the knock-on effects of poverty. It is estimated that world poverty could be cut in half or more if all adults completed secondary education. Other communication attempts besides teaching could also be improved by better systems and methods for doing such.

Thus, new, better, and more interactive systems and methods for providing improved and effective communication, such as in education and teaching, are needed.

Our system can effectively provide one-on-one tutoring with interactivity at scale using our technology.

### SUMMARY OF THE INVENTION

This invention relates to interactive systems and methods for providing improved and effective communication. Certain embodiments provide novel systems and methods by which a human speaker (e.g., a narrator or narrating voice), such as a teacher, actor or instructor, in pre-recorded media, such as audio, video or pre-recorded frames of still or moving images or animation, can provide engagement in an effective one-on-one conversation or natural conversation-like communication. This communication can be provided to one or more members of an audience (“users”) when the speaker is interrupted with a question for a two-way exchange, private or otherwise, and having many such different conversations, even concurrently, even in a language unknown to the speaker in the pre-recorded media, using an artificial intelligence (“AI”) avatar, such AI avatar preferably resembling the speaker in terms of sound and in some cases appearance.

Systems and methods are provided that include media recordings (e.g., audio and/or video) and software programming on one or more servers or computer hard drives that is accessible by users with their own devices. The media recording presents a speaker and a presentation of subject matter being observed by one or more users. The media recording can be interrupted or paused by the user from the user's device with the detection of a signal by the system (e.g., a movement (e.g., raising a hand) or button pushed by the user). The system will then ask, in the voice of the speaker, often through an AI avatar that looks like the speaker, “do you have a question” or some other query, or simply activate the microphone and quietly wait for the user to ask a question. In some embodiments, the AI avatar was created by generative AI and applied to an image of the speaker shown to the user that is using animation, special effects, etc., so that the AI avatar's lips match the speech it communicates to the user. In certain embodiments, the AI avatar speaks with the same fluidity as the speaker, after training using the speech, sentences and content of communications from the speaker. In other embodiments, one or more images of the avatar or simply a still frame of the speaker's image are used with audio recordings. In particularly preferred embodiments, a voice clone of the speaker or another person is used to answer questions without using a moving image animation of the speaker or a clone of the speaker. In these embodiments, one or more static or still images of the speaker or another person may be used. In other embodiments, no images of the speaker or another person are used at least in part of the presentation.

This communication will continue as a two way conversation between the user and the AI avatar. The AI avatar will use the language (e.g., English, Spanish) used (and detected by the system) or requested by the user to respond to any question by the user. Thus, the AI avatar may be capable of providing a response to a question by the user in a language that is not known by the speaker. The AI avatar will preferably use the same natural language, voice, and tone that matches the speaker. Once the conversation is over (e.g., the questions stop, the user requests that it be over, the system detects that the conversation is over (by a period of inaction, or no follow-up question, etc.)), the media presentation continues until it is over or another question is asked by the user, or, a question is asked by the system to the user, or in the case where there are multiple users at the same time, another question is asked by a different user.

Some of the preferred embodiments of this invention are distinguished from merely providing an AI assistant or a chat bot. The preferred embodiments of this invention provide stronger engagement and results with students than such AI assistants and chat bots. These embodiments also go beyond what is provided with Large Language Models (“LLM”)—enabled chatbots.

In certain particularly preferred methods of this invention, the methods accomplish two-way communication concerning pre-recorded media such as a video or an audio recording. The methods comprise a number of steps that may or may not be performed in a particular order. The steps comprise (a) playing the recording that has a beginning and an end, the recording preferably including images of a speaker, wherein the playing of the recording is to a user to watch on a user device, the user device having a screen and a capability to provide a signal when the user has one or more questions about the media presentation. Another step is (b) detecting the signal whenever the user has the one or more questions concerning the recording while it is playing and stopping the playing of the recording for each such question. Another step is (c) receiving one or more questions from the user and (d) responding to each such question using an AI avatar or image(s) of the speaker, wherein the AI avatar and the response is generated using AI and the response is provided in natural language. Another step is (e) continuing the playing of the recording until the user has no additional questions concerning the recording, the system has asked any questions related to the material to the user or the recording has reached its end.

In addition, in these particularly preferred embodiments, there may also be a stopping of the playing of the recording at certain points to ask questions of the user/student in natural language in voice or text, waiting for the user's answer in voice or text, and then proceeding to provide feedback on the user's answer in natural language in voice or text.

In certain of these preferred methods, the speaker could be a teacher and the user could be a student. The signal referred to may be a raised hand, a pushed button, and/or an eye movement. The AI avatar may look like the speaker and sound like the speaker, although in some embodiments it is different people. The response may be provided in a different language than the language used in the presentation or even in a language that is not known by the speaker. The AI avatar may be generated using AI and subject matter from the speaker using known machine learning processes and a base Large Language Model. In addition, these preferred methods may be separately practiced for each student in an entire classroom of users all of whom may not be physically in the same classroom.

In particularly preferred systems of this invention, the systems are used for two-way communication concerning pre-recorded media such as on a video. The systems comprise (a) one or more processors; and (b) memory communicatively coupled to the one or more processors and configured to store instructions that when executed by the one or more processors, cause the one or more processors to perform particular operations. These operations comprise (1) playing media recordings (e.g., audio, video) of a speaker to a user on a user device; (2) stopping the playing of the recording if the user has a question; (3) receiving the question from the user; (4) generating a natural language response to the question using AI; (5) playing the response to the question using an AI avatar of the speaker to the user on the user's device; and (6) continuing the playing of the recording once the question is responded to.

In these particularly preferred embodiments, there may also be (7) stopping to ask a question of the user when a milestone in the lecture is reached, or a lapse in student attention is detected; and (8) recording and processing the response from the student, and providing feedback on the response in voice or text.

In these preferred systems the speaker could be a teacher and the user could be a student. The AI avatar may look like the speaker and sound like the speaker. The response may be provided in a different language then the language used in the video. The AI avatar may be generated using AI and subject matter from the speaker using known machine learning processes and a base Large Language Model. These systems may be applied to each student in an entire classroom of users.

In particularly preferred products of this invention, the product may comprise a non-transitory computer-readable storage medium comprising computer-executable instructions for performing operations concerning two-way communications regarding pre-recorded media (e.g., video, audio). The operations may comprise (a) playing a media recording of a speaker to a user on a user device; (2) stopping the playing of the recording if the user has a question; (3) receiving the question from the user; (4) generating a natural language response to the question using AI; (5) playing the response to the question using an AI avatar of the speaker to the user on the user's device; and (6) continuing the playing of the recording once the question is responded to.

In these particularly preferred embodiments, there may also be (7) stopping to ask a question of user when a milestone in the lecture is reached, or a lapse in student attention is detected; and (8) recording and processing the response from the student, and providing feedback on the response in voice or text.

In these preferred products, the speaker could be a teacher and the user could be a student. The AI avatar may look like the speaker and sound like the speaker. The response may be provided in a different language then the language used in the media. The AI avatar may be generated using AI and subject matter from the speaker using known machine learning processes and a base Large Language Model. These products may be used with each student in an entire classroom of users.

In the past, presentations of pre-recorded media such as videos could not readily respond to questions from users (the audience) during the presentation. In addition, a live or pre-recorded presentation cannot readily and simultaneously answer two different questions from two different users with tailored responses directed to their particular levels. Furthermore, speakers could not provide answers to questions in languages they do not know. This invention solves some or all of these issues.

Advantages of this invention can include the providing of a high quality experience with much lower costs (e.g., less tuition costs, less room and board costs (e.g., live in parents' home)) with flexible scheduling that permits travel and/or income and substantial work by the user or the speaker to occur simultaneously with the experience.

Additional features and advantages of various embodiments will be set forth in part in the description that follows, and in part will be apparent from the description, or may be learned by practice of various embodiments. The objectives and other advantages of various embodiments will be realized and attained by means of the elements and combinations particularly pointed out in the description and appended claims.

### BRIEF DESCRIPTION OF THE DRAWINGS

FIG. 1 is a block diagram showing certain capabilities of an AI avatar embodiment of this invention, including artificial intelligence (AI), automatic speech recognition (ASR), natural language processing (NLP), text to speech generator (TTS) and a graphical user interface (GUI).

FIG. 2 is a flowchart showing certain of the steps of an embodiment of this invention.

FIG. 3 is a flowchart showing certain of the steps of another embodiment of this invention.

FIG. 4 is a schematic of an example of a student workstation that can be used with embodiments of this invention.

### DETAILED DESCRIPTION OF THE INVENTION

Certain preferred embodiments of this invention provide an interactive tool and experience, such as a teaching aid, using AI for increased productivity, reach and individual customization. These embodiments use generative AI to provide life-like avatars for speakers in audio and videos (e.g., narrators, teachers, instructors, etc.). For example, in some embodiments of this invention, video lectures from a teacher are provided to users, with an AI avatar available to answer questions, provide feedback and direct classroom discussion. These audio and video lectures with an AI avatar are provided on users' device or computer screens (e.g., tablets, hand-held devices, monitors) or as part of holograms, with some embodiments including headsets and alternative reality (“AR”) experiences.

In certain embodiments, an application and hardware are provided that permit a speaker (e.g., teacher) to create AI multiples of their likeness and voice that can have realistic conversations on media such as video (e.g., course) material, in small groups or one-on-one, in the speaker's tone, language, style, wit, and humor. In certain preferred embodiments, highly rated speakers with proven success are used to create these avatars. In certain of these embodiments, AI avatars of this invention are capable of communicating in other languages and dialects than the speaker, even stopping to translate and switch between languages.

The AI avatar in preferred embodiments has the same or similar conversations with users as the speaker would have had. In addition, however, the AI avatar in these embodiments has the ability to speak in languages unknown to the speaker. Thus, the system can detect the request for an answer or response from the AI avatar to be in a certain language, or the system can detect that a question was asked in a certain language and respond in that language, whether or not it is known and being used by the speaker.

In certain embodiments the AI avatar is trained in the wit, lead-ins from current events, jokes and/or mannerisms of the speaker, which may help to keep the users engaged.

The AI avatar training process in preferred embodiments will include (input) subject matter from the speaker (e.g., some embodiments may include both a video portion and a speaking or audio portion) using known machine learning and other algorithmic processes and a base LLM, with further custom training by relevant subject matter conversations and audio and video from the speaker so that the AI avatar will represent the speaker and the “speaker's brain” while interacting with the user. This may include direct interaction between the speaker and the AI, including in initial training and in updating and retraining as the system is used more, evaluated, and improved.

In this regard, in certain preferred embodiments of this invention, the experience of the user (e.g., student) is recorded and someone, preferably the speaker and/or the AI will audit the Q&A portions where the users are having a conversation with the AI avatar and augment, edit, update, improve, re-train, etc., the AI avatar or other parts of the experience (e.g., the speaker's portions) as needed or desired.

As one example of on-the-go improving, updating and re-training, the system in some embodiments provides for the inserting of audio and/or video Q&A from other users and answered by either the speaker or the AI avatar to simulate a true classroom effect. Thus, even if a particular user has not asked a question, the system may insert a Q&A segment from a different user. This may break-up the presentation into more interesting segments, change the pace, and improve the user's attention level and experience. It may also be a tool used by the speaker to improve the presentation by reacting to issues of interest to the users, provide additional exposition on particular subject matter if there is confusion or a need for more discussion, etc.

In certain preferred embodiments, the speaker and/or the system may interrupt the presentation without any question or other direct input or request from the user and engage with the user directly. In these embodiments, this may be the result of the user getting sleepy, having prolonged response time, losing interest, etc., which can be measured or detected by eyeball tracking, or some other sensory processing by a computer that shows a drift in attention. The interruption may take the form of the AI avatar doing something, such as answering a question from another user that happened at another time.

In certain embodiments of this invention, the speaker in a presentation is an actual human being, broadly referred to as the “speaker” here, such as an instructor, teacher, actor, technical or motivational speaker, presenter, expert, physician, politician, military leader, religious educator, organizer, etc., and not an entirely “AI being” that never existed in flesh and blood. Instead, the actual person uses embodiments of this invention to expand their reach by incorporating and leveraging AI technology to make the user's experience more tailored and one-on-one like. This may permit the speaker to reach many more times the numbers of listeners or users (e.g., students) and earn more. It may also be a way for the speaker and/or organization sponsoring the presentation to obtain feedback and improve or otherwise change the user's experience.

As an example of an implementation of an embodiment of this invention, a highly rated teacher is used to generate an AI avatar. An undergraduate student at home is watching the teacher's lecture presentation in audio and/or video form that was pre-recorded. During the presentation, the undergraduate student can ask a question. In response, the presentation pauses and the AI avatar takes over to answer the question with a seamless transition and in the manner in which the teacher would answer the question. Twenty other students from diverse locations can synchronize their schedules to form a virtual classroom, engaging in class discussions and activities as if they were all physically present in the same lecture hall. However in contrast with a remote video lecture, different students could be asking different questions at the same time, and getting responses from the instructor's AI avatar. Optionally, these separate questions and answers could be displayed on everyone's screen in the virtual classroom, offering a complete view of the discussion amongst learners, speaker

During the playing of a speaker presentation, in some embodiments, the system may detect a question by voice activation (e.g., “I have a question”), a student raising a hand, eyeball tracking, a mouse click, a key hit on a keyboard, etc., all methods known to a person of skill in the art in virtual reality equipment, computer gaming, etc. From this detection, a message is sent to the system server or local hard disk drive of the user's device. The message activates the AI avatar to appear to the user on the user's device.

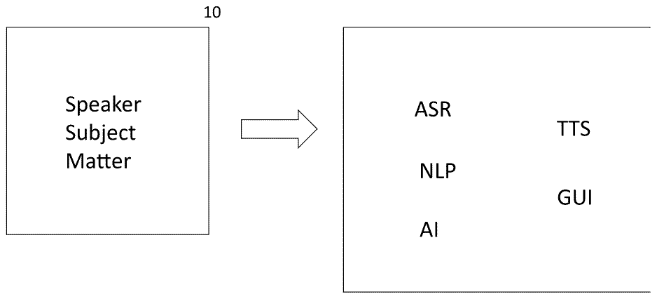

Particularly preferred embodiments of the AI avatar are powered by a combination of generative AI for audio and/or video (e.g., OpenAI's Sora, Synthesia) and a natural language model (e.g., GPT-4). E.g., FIG. 1. The image of the AI avatar appears on screen (or in a hologram) and using the combination of its natural language capabilites and specific training to match the speaker, has a two-way communication or dialog with the user. The communication may be in the form of a voice conversation, chat, combination of voice and chat, or other modes such as retinal or thought (e.g., Neuralink) or other sensory detection and communication.

In preferred embodiments of this invention, the AI avatar response does not come from matching the user's question with a database of anticipated responses. In these embodiments, the response comes from a LLM generated natural conversation that is not pre-scripted. In these embodiments, the AI avatar is also not a built in intelligent mentor, but instead is an AI-version of the speaker that is replicating what the human speaker would have done. An important purpose of these embodiments is to multiply the capabilities of the speaker to extend the speaker's reach using the AI-version of the speaker. In situations where the system is asking questions of the avatar, and there is an expected “correct answer”, our LLL-enabled system makes a semantic evaluation and can comment on the accuracy of the student's response and provide feedback. This is in stark contrast with current systems of e-learning where the students are either given a multiple choice question, because current systems can only evaluate whether the right box was checked, or the system looks for an exact “string” match of the answer against a set of few possibilities [symbol] makes a semantic

[symbol]

Embodiments of this invention can use mixed-reality systems, including from on-screen learning and/or experiencing to the use of AR headsets and holograms, making the experience increasingly “real”. Exceptional speakers (e.g., teachers) could reach an unprecedented number of people (e.g., students) with certain embodiments of this invention and could attain commensurate earnings. Users (e.g., students) from around the world could benefit: for example, a student in Cambodia could access the English curriculum in a Boston school, while a student in Florida could access the math curriculum from a school in South Korea.

In-person schools could adopt embodiments of this invention in whole or in part, which would allow parents to depend on in-person school so they can work and still provide their children with personalized education targeted at each student's level and pace, in applicable languages, solving many of the problems that cause the current systems to fail.

Unlike these embodiments, a teacher at a traditional in-person school could never simultaneously target their teaching for the entire range of students in class. Adult staff could constantly monitor the students, while teachers could be remote and even working at a different full-time day job, providing another solution to the problem of inadequate teacher compensation.

Certain preferred embodiments of this invention also provide the ability to collect data on user (e.g., student) responses to every action from the speaker. This will facilitate research and contribute to improving communication, including in education, and customize experiences (e.g., learning) for every participant, improving their learning, retention, test scores and other key performance indicators.

Certain embodiments of this invention can also be used to provide a knowledge repository (e.g., library) of speakers, including teachers. Thus, for example, a student could create a blended business degree with courses taught by professors from Columbia University, London School of Economics, Berkeley, and Carnegie Mellon University. The professors and their universities could receive a royalty for the taking of their courses.

Certain embodiments of this invention can include a group of like-minded parents crafting a school curriculum with a library of super or otherwise preferred teachers, at a fraction of the cost of current public schools, which may encourage local, regional or national governments to pay the costs.

In some embodiments of this invention, if the speaker is live, on-screen or physically right-in-front of the audience, these embodiments can also be used by the speaker to engage in simultaneous conversations from different parts of the audience, with or without other members of the audience learning about each other's Q&A or conversation, often in languages different from the speaker's language.

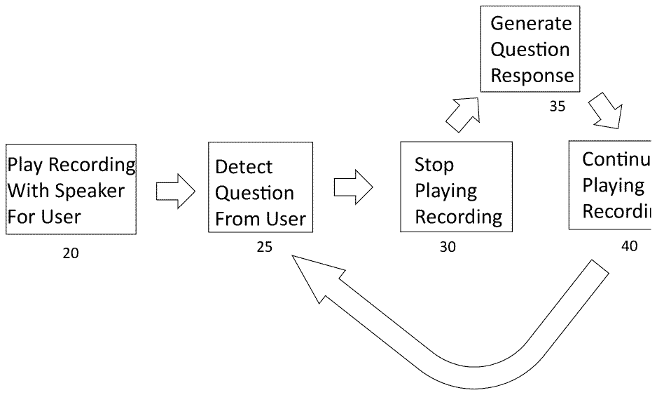

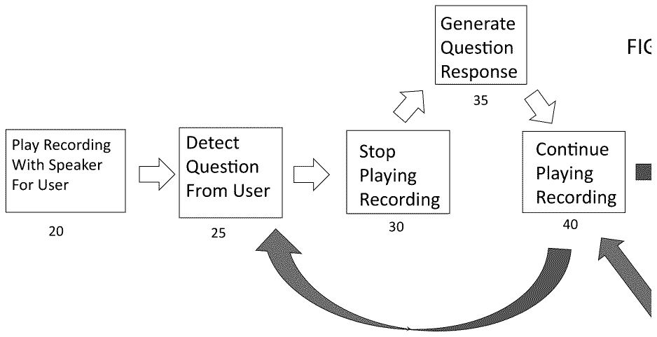

Certain components of the systems and methods of this invention include one or more processors and memory coupled to the one or more processors and configured to store instructions that when executed by the one or more processors cause them to perform operations. The computer executable instructions may be on a non-transitory computer-readable storage medium. These operations can include playing a video and/or audio recording of a speaker, stopping the presentation if the watcher (user) has a question, generating a response to the user's question using AI, playing the response back to the user using an AI avatar of the speaker, and then continue playing the video and/or audio until there is another question from the user or the video reaches its end. E.g., FIG. 2, steps 20 through 40 FIG. 3, steps 20 through 45.

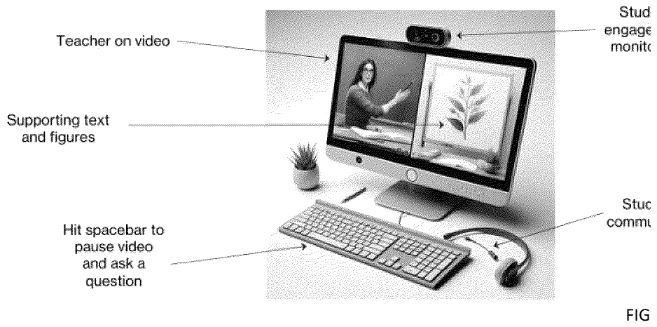

The components of the systems and methods of this invention may reside on a single computer system or multiple servers linked together. The s be on site at caching facility (e. g. in a school or on campus) f-premise (e.g. in a. server farm far away: accessible from the ch FIG. 4 shows an example of a student workstation that can be used with embodiments of this invention.

Natural language processing (computer executable instructions on a non-transitory computer-readable storage medium) capabilities can be used to process user questions and AI avatar responses. Automatic speech recognition processing (similar executable instructions stored on a medium) can be used to convert the user's questions into text. Text to speech capabilites (similar executable instructions stored on a medium) can be used to process the response to the question into speech.

A user profile database may be used to store the results from previous video views and questions concerning videos. This information can be used to improve, tailor and modify the system and methods and the help the AI avatar to be more effective and achieve better results with other users by the speaker and others.

In certain embodiments, an AI avatar generator may be used to generate the AI avatar that will look and sound like the speaker. The gestures, facial expressions, body language, movements, vocalizations, language, idioms, style, etc. of the speaker may be generated after inputting audio, images and/or videos of the speaker, processing the audio/images/videos, and using modeling software to create the desired presentation. It is preferred that the AI avatar appear and sound as close as possible to the speaker. Therefore, a response generator may be used that employs AI to assist in generating a response to a user question that is similar to how the speaker would respond, by using conversations with the speaker, previous responses, natural language processing, etc.

AI capabilities include the capabilites of accepting the input of questions from the users in the form of voice or text, processing such with machine learning, and generating and outputting responses. They also include the accepting of communications regarding the speaking, processing such as with machine learning, and outputting the AI avatar and the AI avatar responses to questions. Such machine learning solutions that perform such processing, comparisons and application filters include IBM Watson, AI markup language, chat scripting, etc.

The user can use a variety of devices, each of which should have at least a microphone, speakers, input capabilities (e.g., keyboard) and a display screen.

### Example 1

In the prior art, a student watches a teaching video that concerns the setting up and solving of algebraic equations from an on-line academy. The student does not understand part of the video, so he goes off and reads the comments, asks friends, and asks his grandfather, but the student gets no clarification. The student moves on, having wasted a few hours, and having a hole in his understanding that the remainder of the student's algebraic training will be founded on.

In embodiments of this invention, the student is watching a video (or listening to an audio presentation with or without still images) of a teacher and when the student comes to a point that is not understood, the student “raises their hand” by pushing a key on the student's computer and asks a question. The presentation stops and the teacher's AI avatar takes over and answers the question. This seals in the student's learning. If the student's first language is not English (or the teacher's language), the AI avatar may give the answer in a language preferred by the student (e.g., Spanish, Italian, Hindi).

These embodiments of this invention do this by using generative AI tools (e.g., OpenAI Sora, etc.). A system server runs in the background generating hundreds of clones of the speaker, ready to answer whatever question a student raises, in the language a student requests (or that the student used for the question). These natural language conversations can be handled by, for example, Cohere's multilingual LLM and other similar AI, which can handle more than 100 languages. These are life-like chat exchanges similar to those provided by chatGPT. These embodiments provide a similar level of dialog/conversation with the AI avatar as with the speaker. The AI avatar looks like the speaker and sounds like the speaker, with the same level of wit, cadence, diction (when speaking English), and other characteristics of the speaker, and, in preferred embodiments with video, with the mouth of the AI avatar matching the speech. These embodiments effectively provide the same one-on-one teaching/tutoring at any time, by any student, in any location, greatly multiplying the reach of the teacher.

In these embodiments, the student's experience is also customized to the student's levels and needs based on the student's past performance and history.

### Example 2

A math teacher is teaching geometry. The teacher gets two questions from students that are at two completely different levels. In a live classroom, the teacher must play a balancing act between the students and the levels, and the strongest and weakest students both suffer, as the teacher provides the answer that most students will understand and be able to use.

In an embodiment of the system and method of this invention, the teacher is using an interactive video and/or audio presentation to teach the same subject matter. When the two questions are asked, the AI avatar of the teacher can provide different answers to the students in the classroom through their individual headsets, depending on their individual needs and in that way the chance of anyone being left behind is reduced.

### Example 3

In this example the interactive presentation of this invention is a movie (e.g., a superhero movie) and the user is watching the movie in their home. At set times in the movie, that may be indicated by some symbol or sign on the screen, the user can use a system and method of this invention to stop the video and ask a question of an actor in the movie. An AI avatar of the actor will respond to the question or otherwise converse with the user. When the conversation is over, the video will continue. The AI avatar of the actor had been made and kept on the system beforehand. The AI avatar had been trained using, for example, video and communications with the actor.

### Example 4

In this example the interactive presentation of this invention is a Ted Talk or other similar video (e.g., podcast) and the user is watching the video in their home. At any time in the video, the user can use a system and method of this invention to stop the video and ask a question of the presenter. An AI avatar of the presenter will respond to the question or otherwise converse with the user. When the conversation is over, the video will continue. The AI avatar of the presenter had been made and kept on the system beforehand. The AI avatar had been trained using video and communications with the presenter.

### Particular Applications To Computer Devices

The system applied to this invention may include a plurality of different computing device types. In general, a computing device type may be a computer system or computer server. The computing device may be described in the general context of computer system executable instructions, such as program modules, being executed by a computer system (described for example, below). In some embodiments, the computing device may be a cloud computing node (for example, in the role of a computer server) connected to a cloud computing network (not shown). The computing device may be practiced in distributed cloud computing environments where tasks are performed by remote processing devices that are linked through a communications network. In a distributed cloud computing environment, program modules may be located in both local and remote computer system storage video including memory storage devices. Graphical user interfaces permit accessing the devices by users, speakers, and others.

The computing device may typically include a variety of computer system readable media. Such media could be chosen from any available media that is accessible by the computing device, including non-transitory, volatile and non-volatile media, removable and non-removable media. The system memory could include random access memory (RAM) and/or a cache memory. A storage system can be provided for reading from and writing to a non-removable, non-volatile magnetic media device. The system memory may include at least one program product having a set (e.g., at least one) of program modules that are configured to carry out the functions of embodiments of the invention. The program product/utility, having a set (at least one) of program modules, may be stored in the system memory. The program modules generally carry out the functions and/or methodologies of embodiments of the invention as described herein.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects “system.” Furthermore, aspects of the disclosed invention may take the form of a computer program product embodied in one or more computer readable media having computer readable program code embodied thereon.

Aspects of the disclosed invention are described above with reference to block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

### Other Embodiments

Although the present invention has been described with reference to teaching, examples and preferred embodiments, one skilled in the art can easily ascertain its essential characteristics, and without departing from the spirit and scope thereof can make various changes and modifications of the invention to adapt it to various usages and conditions. Those skilled in the art will recognize or be able to ascertain using no more than routine experimentation, many equivalents to the specific embodiments of the invention described herein. Such equivalents are encompassed by the scope of the present invention.

What is claimed is:

1. A method for two-way communication concerning pre-recorded media comprising:
(a) playing a media recording comprising video and/or audio that has a beginning and an end, the recording including images of a speaker, wherein the playing of the recording is to a user to watch on a user device, the user device having a screen and a user interface which allows the user to input a signal when the user has one or more questions about the content/recording;
(b) detecting the signal whenever the user has the one or more questions concerning the recording while the recording is playing and stopping the playing of the recording for each such question;
(c) receiving one or more questions from the user;
(d) responding to each such question using an artificial intelligence (“AI”) avatar of the speaker, wherein the AI avatar and the response is generated using AI and the response is provided in natural language, the natural language provided by communication comprising video, audio, text, or hologram image;
(e ) stopping the playing of the recording at certain points to ask questions of the user/student, in natural language in voice or text, waiting for the user's answer in voice or text, and proceeding to provide feedback on the user's answer, in natural language in voice or text; and
(f) continuing the playing of the recording until the user has no additional questions concerning the recording and the recording has reached its end.

2. The method of claim 1 wherein the speaker is a teacher and the user is a student.

3. The method of claim 1 wherein the signal is a raised hand, a pushed button, a keystroke on the keyboard, and/or an eye movement.

4. The method of claim 1 wherein the AI avatar looks like the speaker and sounds like the speaker.

5. The method of claim 1 wherein the response is provided in a different language then the language used in the recording.

6. The method of claim 1 wherein the avatar is generated using AI and subject matter from the speaker using known machine learning processes and a base Large Language Model.

7. The method of claim 1 wherein the method is separately practiced for each student in an entire classroom or distributed collection of users, the distributed collection of users comprising users separated by great distances.

8. A system for two-way communication concerning pre-recorded media, the media comprising audio and/or video, the system comprising:
(a) one or more processors; and
(b) memory communicatively coupled to the one or more processors and configured to store instructions that when executed by the one or more processors, cause the one or more processors to perform operations comprising:
(1) playing a recording of a speaker to a user on a user device;
(2) stopping the playing of the recording if the user has a question;
(3) receiving the question from the user;
(4) generating a natural language response to the question using AI;
(5) playing the response to the question using an AI avatar of the speaker to the user on the user's device;
(6) continuing the playing of the recording once the question is responded to;
(7) stopping to ask a question of the user when a milestone in the lecture is reached, or a lapse in student attention is detected; and
(8) recording and processing the response from the student, and providing feedback on the response in voice or text.

9. The system of claim 8 wherein the speaker is a teacher and the user is a student.

10. The system of claim 8 wherein the AI avatar looks like the speaker and sounds like the speaker.

11. The system of claim 8 wherein the response is provided in a different language then the language used in the video.

12. The system of claim 8 wherein the AI avatar is generated using AI and subject matter from the speaker using known machine learning processes and a base Large Language Model.

13. The system of claim 8 wherein the system is separately applied to each student in an entire classroom of users.

14. A non-transitory computer-readable storage medium comprising computer-executable instructions for performing operations concerning two-way communications regarding pre-recorded media, the media comprising video and/or audio, the operations comprising:
(1) playing a media recording of a speaker to a user on a user device;
(2) stopping the playing of the recording if the user has a question;
(3) receiving the question from the user;
(4) generating a natural language response to the question using AI;
(5) playing the response to the question using an AI avatar of the speaker to the user on the user's device;
(6) continuing the playing of the recording once the question is responded to.
(7) stopping to ask a question of the user when a milestone in the lecture is reached, or a lapse in student attention is detected; and
(8) recording and processing the response from the student, and providing feedback on the response in voice or text

15. The medium of claim 14 wherein the speaker is a teacher and the user is a student.

16. The medium of claim 14 wherein the AI avatar looks like the speaker and sounds like the speaker.

17. The medium of claim 14 wherein the response is provided in a different language then the language used in the recording.

18. The medium of claim 14 wherein the AI avatar is generated using AI and subject matter from the speaker using known machine learning processes and a base Large Language Model.

19. The medium of claim 14 wherein the operations are separately applied to each student in an entire classroom of users.

20. A method for two-way communication concerning pre-recorded video comprising:
(a) playing a video that has a beginning and an end, the video including images of a speaker, wherein the playing of the video is to a user to watch on a user device, the user device having a screen and a capability to provide a signal when the user has one or more questions about the video;
(b) detecting the signal whenever the user has the one or more questions concerning the video while the video is playing and stopping the playing of the video for each such question;
(c) receiving one or more questions from the user;
(d) responding to each such question using an artificial intelligence (“AI”) avatar of the speaker, wherein the AI avatar and the response is generated using AI and the response is provided in natural language;
(e) continuing the playing of the video until the user has no additional questions concerning the video and the video has reached its end.

21. A system for two-way communication concerning pre-recorded video comprising:
(a) one or more processors; and
(b) memory communicatively coupled to the one or more processors and configured to store instructions that when executed by the one or more processors, cause the one or more processors to perform operations comprising:
(I am wondering if the above description of “the system” refers to a “local” or ‘on-premise’ system, and does not cover a system where the software, and videos are actually stored on a remote server, which might be 1000 ft away from the student, and supporting the entire school, or somewhere remote in a cloud server thousands of miles away. The use of servers will likely be essential in doing this at scale, and I don't want someone to file a minor extension of this patent with a server in the loop, and block us from using servers.)
(1) playing a video of a speaker to a user on a user device;
(2) stopping the playing of the video if the user has a question;
(3) receiving the question from the user;
(4) generating a natural language response to the question using AI;
(5) playing the response to the question using an AI avatar of the speaker to the user on the user's device;
(6) continuing the playing of the video once the question is responded to.
(7) stopping to ask a question of the user when a milestone in the lecture is reached, or a lapse in student attention is detected; and
(8) recording and processing the response from the student in the above, and providing feedback on the response in voice or text.

22. The system of claim 21, wherein the one or more processors and the memory are resident on an on-premise system in a school or other teaching facility.

23. The system of claim 21, wherein the one or more processors and the memory are resident on a remote server that is not on-premise in a school or other teaching facility.

24. A non-transitory computer-readable storage medium comprising computer-executable instructions for performing operations concerning two-way communications regarding pre-recorded video, the operations comprising:
(1) playing a video of a speaker to a user on a user device;
(2) stopping the playing of the video if the user has a question;
(3) receiving the question from the user;
(4) generating a natural language response to the question using AI;
(5) playing the response to the question using an AI avatar of the speaker to the user on the user's device; and
(6) continuing the playing of the video once the question is responded to.
(7) stopping to ask a question of the user when a milestone in the lecture is reached, or a lapse in student attention is detected; and
(8) recording and processing the response from the student in the above, and providing feedback on the response in voice or text
